(19) United States
(12) Patent Application Publication
(10) Pub. No.: US 2011/0292546 A1
(43) Pub. Date: Dec. 1, 2011

(54) TIMING TRACK FOR MASTER TEMPLATE SUBSTRATE

(75) Inventors: Dave Marcus Tung, Livermore, CA (US); Sundeep Chauhan, Fremont, CA (US); David Kuo, Palo Alto, CA (US); Shih-Fu Lee, Fremont, CA (US)

(73) Assignee: Seagate Technology LLC, Scotts Valley, CA (US)

(21) Appl. No.: 12/786,821

(22) Filed: May 25, 2010

(51) Int. Cl. G11B 5/82; G11B 5/84

(52) U.S. Cl. 360/135; 216/22; 216/59; 216/60; G9B/5.293

(57) ABSTRACT

A patterned recording media is formed from a master template that includes a data area and a timing track area having a final timing track. In order to form the final timing track, a first timing track is etched into master template and tested for accuracy by comparing the angular position of the master template to the timing track. If errors are detected in the timing track, the errors are used to create additional timing tracks which are etched into the master template. This process of improving the timing track is repeated until a final timing track is formed that has errors below a predetermined level. The timing tracks formed prior to the final timing track are removed and the master template is used to make stampers which are used to make patterned media disks.

### FIELD

This disclosure relates to a method for creating a master template that includes a timing track.

### BACKGROUND

Traditional magnetic storage media, such as those employed in disc drives, are uniform and continuous. The density with which data can be written is constrained by the superparamagnetic limit. A way to overcome the constraints of the superparamagnetic limit is to organize the magnetic media into a series of individual islands. This structure can increase the data density that can be achieved over traditional media.

### BRIEF DESCRIPTION OF THE DRAWINGS

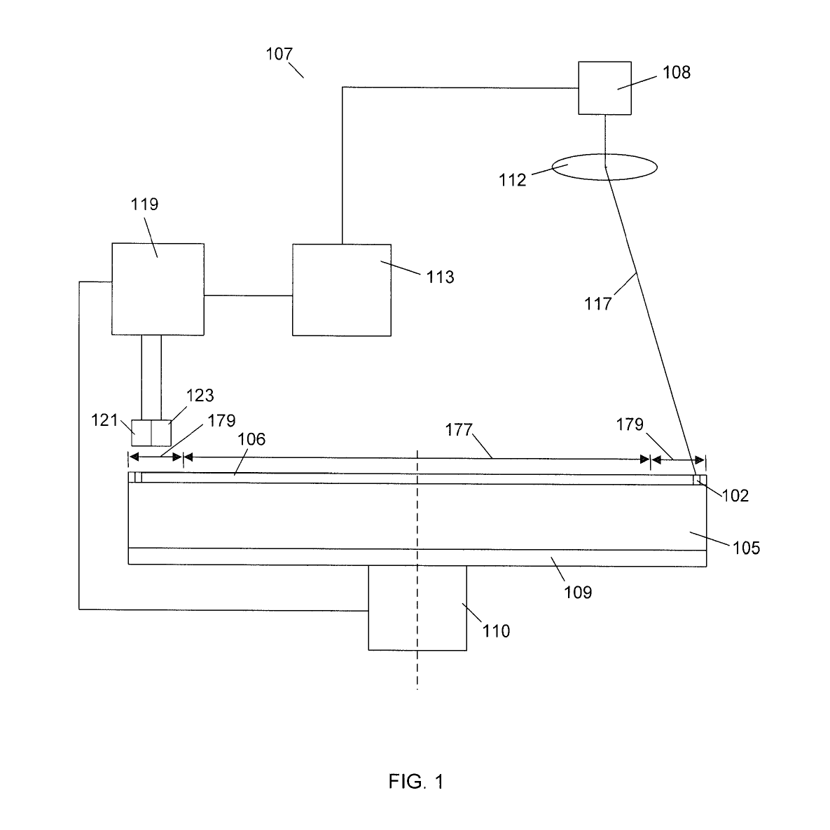

According to an embodiment, FIGS. 1-3 illustrate a master template fabrication tool;

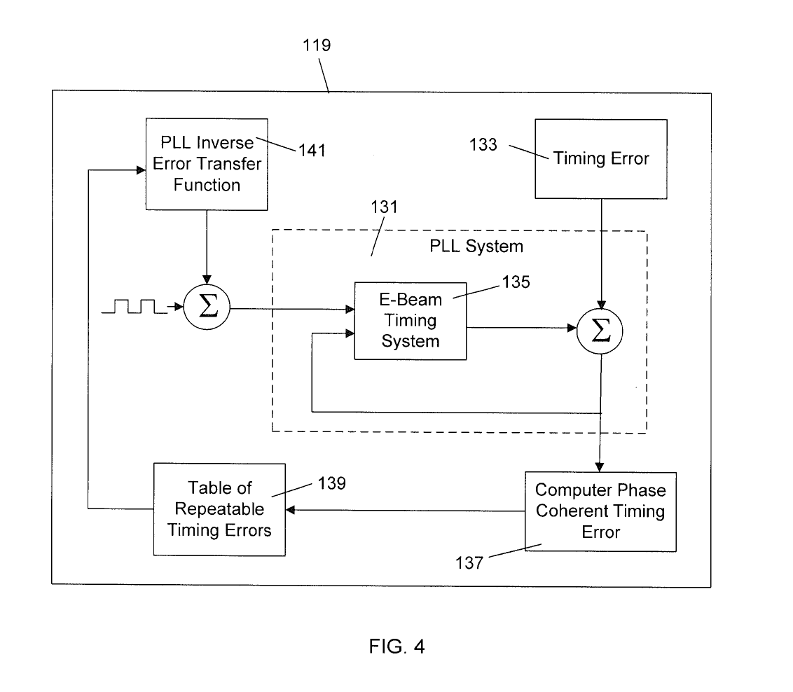

According to an embodiment, FIG. 4 illustrates a block diagram of a timing correction module;

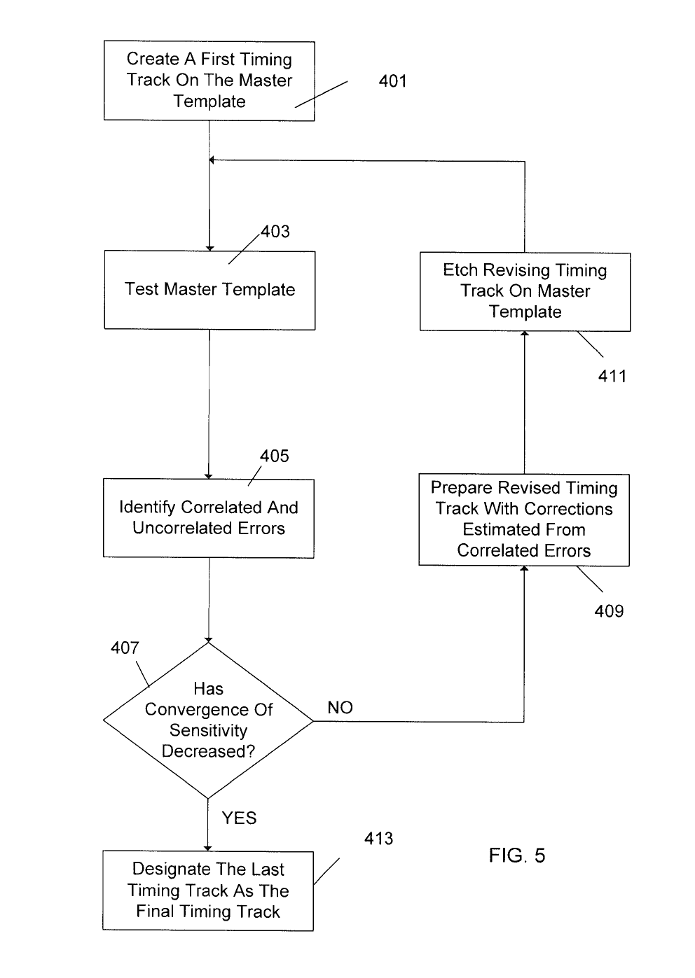

According to an embodiment, FIG. 5 illustrates a flow chart for creating a final master template;

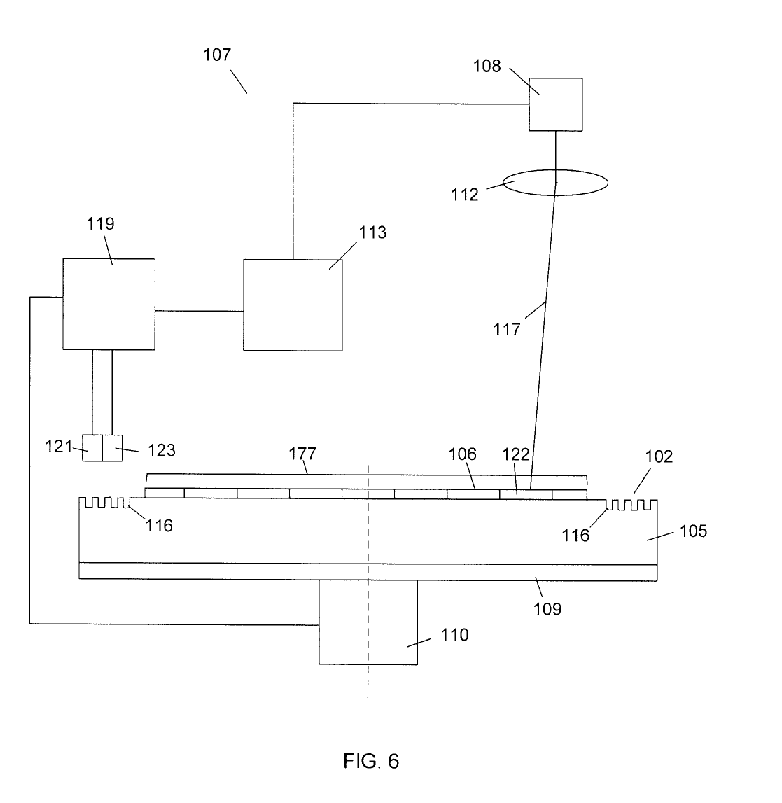

According to an embodiment, FIG. 6 illustrates a master template fabrication tool;

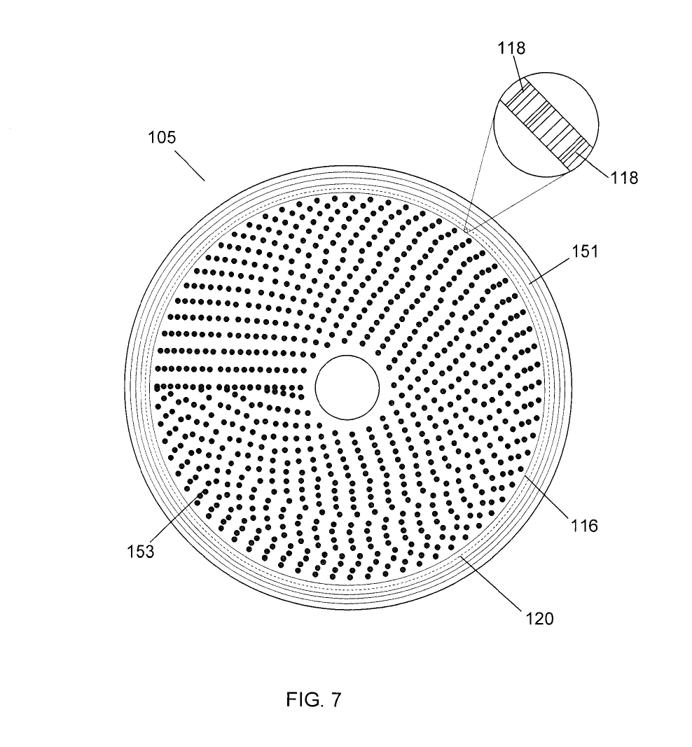

According to an embodiment, FIG. 7 illustrates a top view of a master template;

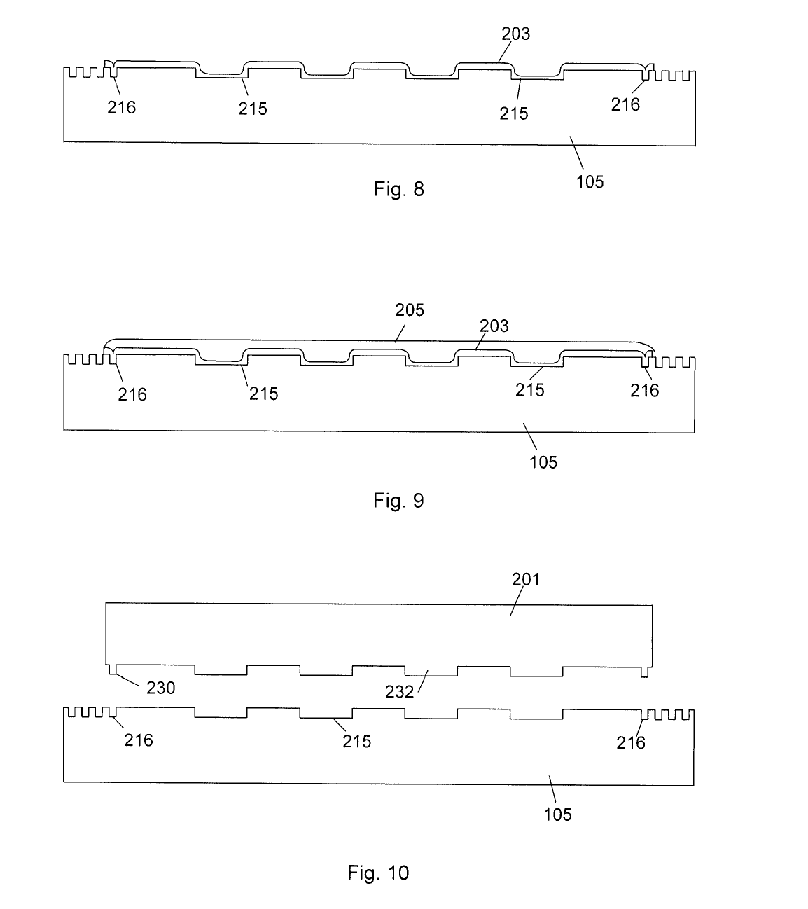

According to an embodiment, FIGS. 8-10 illustrate process steps for forming a stamper from the final master template;

According to an embodiment, FIGS. 11-18 illustrate steps for forming a patterned magnetic media disk with hard magnetic elements and an etched final timing track;

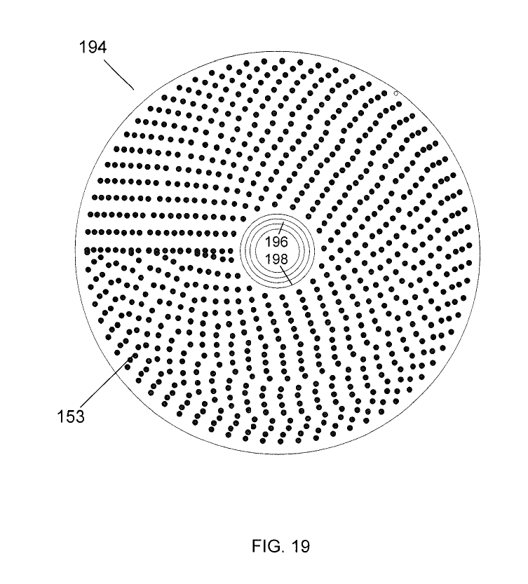

According to an embodiment, FIG. 19 illustrates a top view of a master template; and

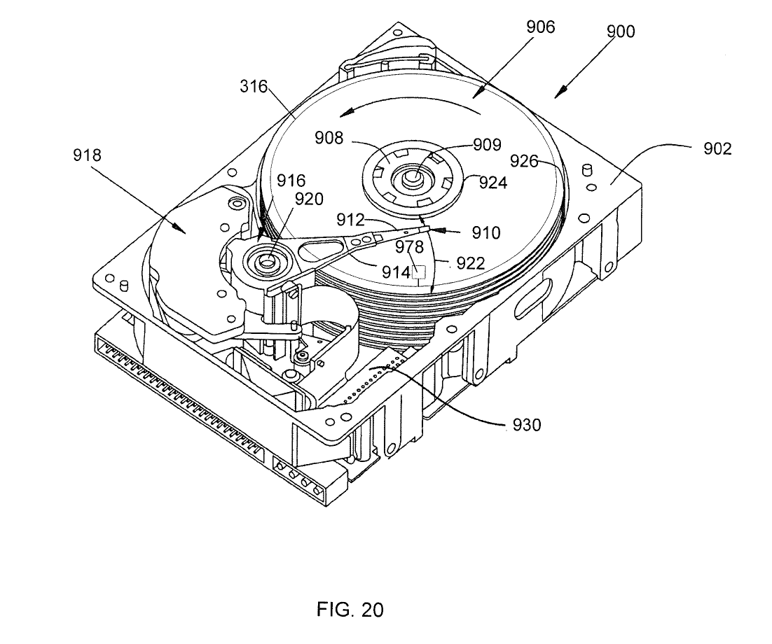

According to an embodiment, FIG. 20 illustrates a view of a disk drive.

### DETAILED DESCRIPTION

The embodiments may relate to a method and apparatus for producing patterned magnetic media. Patterned magnetic media generally refers to magnetic data and information storage and retrieval media having a plurality of discrete, independent regions of magnetic material which form discrete, independent magnetic elements or islands that each function as a recording bit. The magnetic elements can be formed on a non-magnetic substrate. Since the regions of ferromagnetic material comprising the magnetic bits or elements are independent of each other, mutual interference between neighboring bits can be minimized. As a consequence, bit patterned media (“BPM”) may have reduced recording losses and noise arising from neighboring magnetic bits in comparison to conventional magnetic recording media. In addition, patterning of the magnetic layer might increase resistance to domain wall movement and may also increase the magnetic performance characteristics. In other embodiments, “patterned magnetic media” can encompass other types of pattern formation and different types of recording media with patterned surfaces, including, but not limited to, servo-patterned magnetic and magneto-optical (“MO”) media and discrete track recording (“DTR”) media.

In BPM, each magnetic bit or element can have the same size and shape, and each can be composed of the same magnetic material as the other elements. Each discrete magnetic element forms a single magnetic domain or bit and the size, area, and location of each domain is determined during the fabrication process. The elements are arranged in a regular pattern of circular tracks on the substrate surface, with each element having a small size and desired magnetic anisotropy, so that, in the absence of an externally applied magnetic field, the magnetic moments of each discrete magnetic element are aligned along the same magnetic easy axis. BPM have been fabricated using a variety of processing techniques, including deposition and etch to form a pattern of hard magnetic elements arranged in tracks. A non-magnetic material fills the areas between the hard magnetic elements on a media substrate.

The elements or bits of the patterned magnetic media generally have perpendicularly oriented magnetic easy axis. The perpendicular orientation achieves higher areal recording densities. Thus, in a perpendicular orientation, the magnetic moment of each discrete magnetic element has only two states: up or down. The magnetic states have the same magnitude. During the writing operation of BPM, the direction of the magnetic moment of the single magnetic domain element or bit is flipped along the easy axis by the write head, and during the reading operation, the direction of the magnetic moment of the single magnetic domain element or bit is sensed by the read head.

BPM is substantially different than conventional disk media. Specifically, the writing process is greatly simplified, resulting in much lower noise and lower error rate, thereby allowing much higher areal recording density. In BPM, the writing process does not define the location, shape, and magnetization value of a bit, but merely flips the magnetization orientation of a patterned single domain magnetic structure. In theory, the writing of data to BPM can be perfect, even when the transducer head deviates slightly from the intended bit location and partially overlaps neighboring bits, as long as only the magnetization direction of the intended bit is flipped. In contrast, with conventional disk media, if the transducer head deviates from the intended location, the head may write to part of the intended bit and to part of the neighboring bits. Another difference of BPM is that crosstalk between neighboring bits is reduced relative to conventional media, whereby areal recording density is increased. Each individual magnetic element, domain, or bit of a patterned medium can be tracked individually, and reading is less jittery than in conventional disks.

In an embodiment, a master template is used to make stampers that are then used to fabricate the patterned media disks. The master template can include a data area and a timing track area. The data area includes physical features that can be used to form the magnetic elements or islands on the BPM disks and the timing track area includes a plurality of parallel and concentric timing tracks. The timing track area can include a final timing track that extends around an annular portion of the master template. The final timing track can be transferred to an annular portion of the BPM disks and can be used in a disk drive to locate the magnetic elements on the BPM disks.

With reference to FIG. 1, a master template 105 is illustrated during fabrication by a master template tool 107 that is controlled by a computer 113. The master template 105 can be made from Si, quartz and other suitable materials that can be etched. The master template 105 is placed on a rotary stage 109 and the rotational position of the template is controlled by a motor 110. By rotating the stage 109 the master template tool 107 can form the timing track in a circle in the master template 105. The electron beam tool 107 includes an electron source 108 which can be an electron gun that emits an electron beam 117. The radial position of the electron beam 117 can be controlled by a magnetic lens or beam deflector 112 to move across the width of the master template 105. By rotating the rotary stage 109 and deflecting the electron beam 117, any area of the master template 105 can be exposed to the electron beam 117. The electron beam tool 107 also includes a laser 121, a sensor 123 and a timing correction module 119.

In an embodiment, the master template 105 may be fabricated using an electron beam lithography process. The patterned master template 105 is coated with a layer of a resist material 106 and the electron beam 117 can be directed at the master template 105 to cure areas of the resist material 106 in the pattern. In an embodiment, the cured resist 106 is removed from the master template 105 and the exposed areas are etched using a known etch process such as reactive ion etching to create the patterned master template 105.

The master template 105 can include a timing track area 179 and a data storage area 177. The timing tracks can be formed in the timing track area 179 before the data features are formed in the data storage area 177. In this example, the timing track area 179 is an annular area that is adjacent to the outer diameter of the master template 105 and surrounds the data storage area 177. In other embodiments, the timing track area 179 can be located on any other portion of the master template 105. The electron beam 117 can form a pattern 102 in the resist material 106 for the first timing track over the timing track area 179 adjacent to the outer diameter of the master template 105 and the patterned resist 106 is used to etch the first timing track into the master template 105.

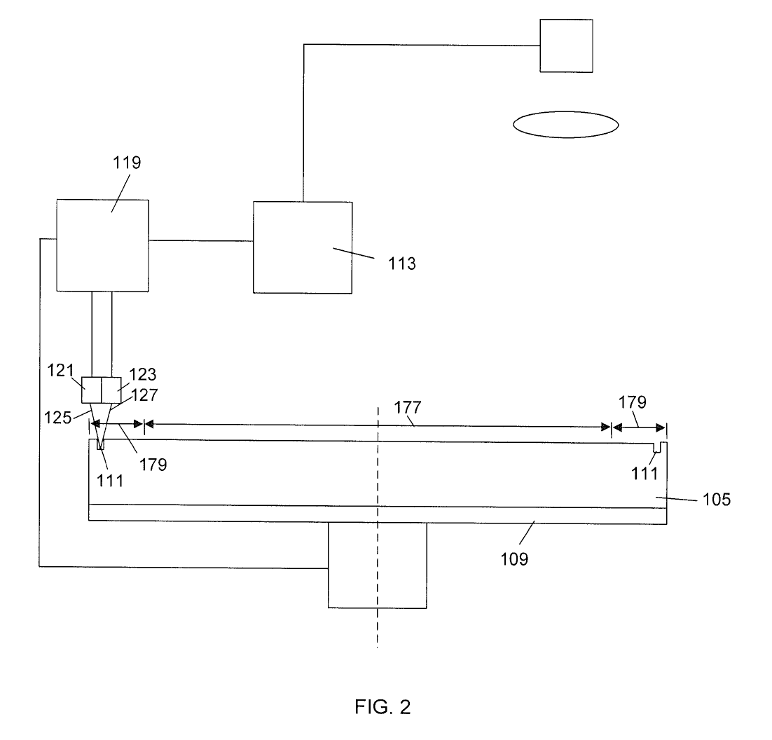

With reference to FIG. 2, the first timing track 111 has been etched into the master template 105. The timing track 111 can include timing data regarding the angular position of the master template 105. The timing data can be in the form of an etched grating that includes a plurality of etched lines across the width of the timing track 111. The grating extends around the entire circular timing track 111.

In an embodiment, the timing data is read from the timing track 111 using an optical detection system. A laser 121 emits a beam 125 at the timing track 111 and the reflected light 127 is detected by a sensor 123. The timing track data is analyzed by a timing correction module 119 to determine if the data from the timing track accurately corresponds to the rotational position of the master template 105. The timing correction module 119 can read the timing track 111 several times, possibly 5-10 or more times. The timing track data is compared to the detected rotational position of the master template 105. The timing correction module 119 detects any errors between the timing track 111 and true the rotational position of the master template 105. The difference between the timing track 111 and the true rotational position of the master template 105 can be measured in time. For example, the timing track 111 can indicate that the master template 105 will be at a rotational position at a specific time based upon the rotational velocity of the master template 105. The timing correction module 119 may detect that the timing track 111 data does not accurately indicate the true rotational position of the master template 105 and this error can be quantified by a time measurement. The correction module 119 can then generate corrected timing track data based upon all of the detected errors in the timing track 111. The more accurate timing track data is stored in memory and the timing track formation process can be repeated using the lithography process described above in FIG. 1.

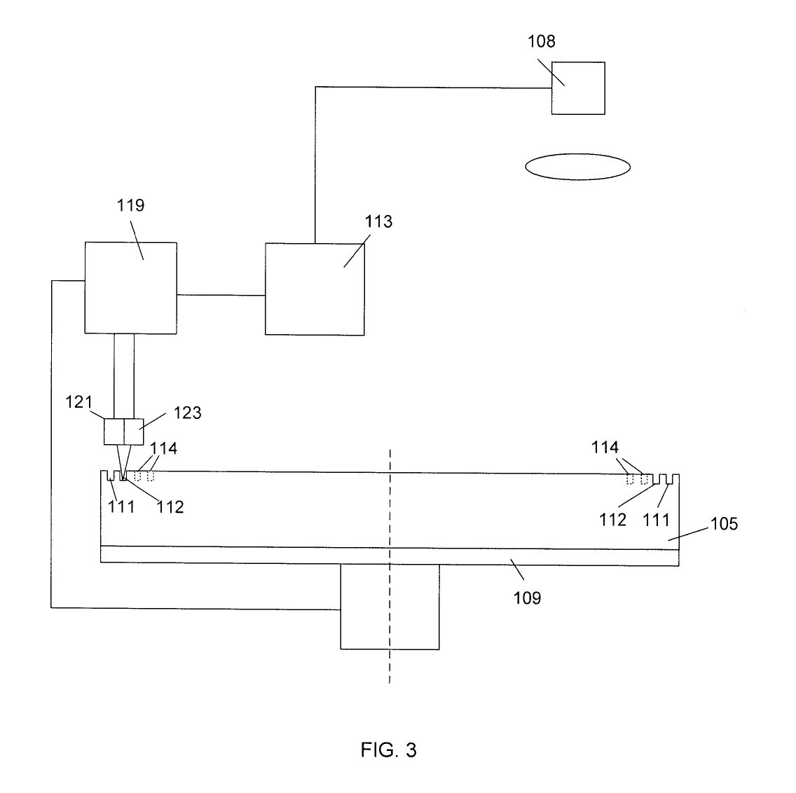

With reference to FIG. 3, a second timing track 112 can be formed on the master template 105 based upon the more accurate timing track data. The described testing process is repeated on the second timing track 112 and if errors are detected, additional timing tracks 114 are formed on the master template 105. As the timing tracks 114 becomes more accurate with each iteration, eventually one of the timing tracks 114 may meet the predetermined accuracy value, which can be less than 2 nanoseconds (ns).

With reference to FIG. 4, a more detailed illustration of the timing correction module 119 is illustrated. The timing correction module 119 includes a phase lock loop (PLL) system 131. The timing errors 133 are detected and transmitted to the PLL system 131 where they are combined with output data from the E-beam Timing system 135. The output from the PLL system 131 is computer phase coherent timing errors 137. Rather than testing the timing track once, the system can test the timing track multiple times. Errors that are consistently detected are “correlated errors” and errors that are detected intermittently are “uncorrelated errors.” The correlated errors are stored in a database or table of repeatable timing errors 139. The table of repeatable timing errors is transmitted to the PLL Inverse Error Transfer Function 141 which estimates the corrections to the timing track that can be used to eliminate the correlated errors. The corrections are combined with a square wave data and transmitted back to the E-Beam Timing System 135 in the PLL system 131. The PLL system 131 also includes a feedback loop for the E-Beam Timing System 135. Based upon this process, the timing correction module 119 produces more accurate timing track data that can then be used to form a more accurate timing track on the master template.

With reference to FIG. 5, a flow chart of the process for forming the master template is illustrated. The process for forming the timing track can be an adaptive system. Improvements to the timing track can occur more quickly in the initial timing tracks. Thus, there can be a high rate of change or a high sensitivity. As the timing tracks improve and approach the final timing track, the rate of change slows down becoming more asymptotic. This slowing change is also known as a “convergence of sensitivity” which indicates that timing track can be converging to the final timing track. A master template having a first timing track is created with an electron beam 401. The master template is then tested 403 and an algorithm can be used to identify correlated and uncorrelated errors in the timing track 405. The algorithm may also determine if the convergence of sensitivity has decreased 407. The timing tracks correction is an adaptive system that corrects errors in the timing track. If the convergence of sensitivity has not decreased, the algorithm is used to prepare a revised timing track with corrections estimated from the correlated errors 409. The revised timing track is then etched into the master template adjacent to the previous timing track 411. The disk media creation and testing steps 403-411 are repeated until the convergence sensitivity decreases indicating that the last timing track is within the predetermined accuracy. The disk drive must be able to read the timing track and accurately detect the rotational position of each hard magnetic element on the BPM disk. The last timing track becomes the final timing track. All of the prior timing tracks can be left on the master template or they may be removed.

The final timing track can have nanometer-scale accuracy and even very small errors can result in etching defective timing data. Errors can occur for various reasons. For example, movement, noise and magnetic fields from the stage motor, electrical circuitry, the phase lock loop (PLL) circuitry, master template stage, thermal expansion, disk distortion, etch processing, etc., can all alter the intended position of the electron beam and even a small error of a few nanometers can result in defects in the timing tracks formed on the master template.

In an embodiment, the timing error is measured in units of phase or time. The accuracy of the final timing track can be set for a specific predetermined phase or time value. The predetermined timing error value can be related to the data density on the BPM. A higher timing track accuracy is required for a higher data density on a BPM. For example, the timing error may need to be less than 2 nanoseconds (ns). As more hard magnetic elements are placed on the BPM disk, the predetermined timing error value of the final timing track may need to be adjusted to a lower value, for example less than 0.5 nanosecond (ns).

The error in the timing track can be measured and quantified in units of phase or time. The predetermined accuracy of the timing track can depend upon the geometry of the hard magnetic elements on the BPM disk. As disk drive technology progresses, the hard magnetic element size and spacing between elements may become smaller and higher timing track accuracy may be desirable. The number of iterations to get the timing track to the predetermined error rate can be estimated and may depend upon the accuracy of the first timing track and the predetermined accuracy. In an embodiment, the accuracy of the timing tracks can be estimated by the equation, E₁/(n)^{0.5}=Eₙ where E is the error and n is the number of timing track iterations. Alternatively, this equation can be n=(E₁/Eₙ)². An initial timing track can have an error rate E₁ of about 3 nanoseconds (ns) and the BPM disk may have an error rate Eₙ of less than 2 ns. Applying the equation, n=( 3/2)²=2.25. Thus, an estimated 3 iterations can be used to get to the predetermined timing track error rate. For additional accuracy, additional iterations may be performed. For example, if the initial error rate is 3 ns and the predetermined error rate is less than 1 ns, n=( 3/1)²=9 iterations may be performed. As BPM technology progresses, the initial timing track may have an error of about 0.8 ns and the final timing track error may be less than 0.3 ns. Because the system can determine when the timing track is close to the predetermined accuracy, the system can accurately predict the final timing track before it is etched on the master template.

With reference to FIG. 6, the final timing track 116 is used to form the data area features 122 on the master template 105. After the final timing track 114 is formed, the resist 106 can be placed over the data area 177 of the master template 105 and the master template tool 107 can use the final timing track 116 to precisely position the data area features 122 on the master template 105. In an embodiment, the master template tool 107 may detect rotational position of the master template 105 from the final timing track 116 to accurately control the exposure of the resist 106 to the electron beam 117. The rotational position detection during the data area fabrication increases the position accuracy of the data features on the master template 105 and patterned media formed from the master template 105. The data features can be a plurality of islands on the master template 105.

With reference to FIG. 7, a top view of a final master template 105 is illustrated. In an embodiment, the timing track area 151 is adjacent to the outer diameter of the master template 105 and the data storage area 153 is inside the timing track area 151. The timing track area 151 can have enough room for about 10-20 timing tracks and can be less than about 5 mm wide. It may take about 5-10 iterations to obtain the final timing track 116. When the final timing track 116 is created, the prior timing tracks can be removed. The final timing track 116 has timing data that can be stored as a grating that includes raised and recessed portions 118 that extend across the width of the timing track 116. The distance between the raised and recessed grating features 118 can be less than 200 nm. In other embodiments, the timing track area can be on another portion of the disk media. For example, the timing track area can occupy the inner portion of the disk and be surrounded by the data storage area or the middle portion of the disk.

The dashed line 120 can represent the outer diameter of a stamper. The final timing track 116 can be the only timing track that is inside the outer diameter of the stamper and the only the final timing track 116 may be transferred to the patterned media made from the master template 105. In other embodiments, the outer diameter of the stamper can be smaller than the diameter of the final timing track 116 and none of the timing tracks may be transferred to the stamper and patterned media.

A plurality of stampers can be created from the master template. Various different methods can be used to create the stampers. In an embodiment illustrated in FIG. 8, a thin conformal layer 203 of an electrically conductive material (e.g., Ni) is deposited over the master template 105. The conformal layer 203 is able to fill all of the final timing track recesses 216 and the data area recesses 215 formed in the master template 105. With reference to FIG. 9, a substantially thicker “blanket” metal layer 205 (e.g., Ni) is deposited on the thin layer 203 of electrically conductive material. Because the thin conformal layer 203 has already filled the small recesses, the blanket metal layer 205 can be deposited more rapidly since the stamping surface has already been formed.

With reference to FIG. 10, upon completion of the electroforming process, the stamper 201 is separated from the master template 105. In this example, all of the data area features 232 are transferred to the stamper 201 and the final timing track 230 is transferred to the stamper 201. Many stampers 201 can be formed from each master template 105 and various other fabrication methods can be used to create the stampers 201 from the master template 105. Although the stamper 201 in this example is made of metal such as Ni, in other embodiments, stampers 201 can be made from a number of materials such as etched Si, etched quartz or glass, electroformed metals, dielectrics, semiconductors, ceramics, and composite materials.

The stamper 201 is used to create patterned magnetic media disks having a final timing track. In an embodiment, a thermally assisted nanoimprint lithographic process is used for forming nano-dimensioned patterns and features in a substrate surface to form the patterned recording media. The thermally assisted nanoimprint lithography is described in U.S. Pat. Nos. 4,731,155; 5,772,905; 5,817,242; 6,117,344; 6,165,911; 6,168,845 B1; 6,190,929 B1; and 6,228,294 B1.

Referring to FIG. 11, the stamper 201 includes an imprinting surface that includes the timing track features 230 and data features 232. A thin film layer 305 of a nanoimprint resist is placed on an upper surface of the patterned media substrate 301. The thin film layer 305 of nanoimprint resist can be a thermoplastic polymer material, such as polymethylmethacrylate (PMMA), that may be formed on the substrate 301 surface by any appropriate technique, such as spin coating. The material of the imprinting surface can be selected to be hard relative to the thin film layer 305 which can soften when heated above the glass temperature, T_{g}, such that the material exhibits low viscosity and enhanced flow.

With reference to FIG. 12, a compressive molding step is shown. The stamper 201 is pressed into the thin film layer 305 and depressed or compressed regions 311 are formed. In the illustrated embodiment, data features 232 and timing features 230 of the stamper 201 are not pressed all of the way through the thin film layer 305 and thus, the data features 232 and timing features 230 do not contact the underlying substrate 301. However, the top surface portions of the thin film 305 may contact recessed portions of the stamper 201 and the top surface portions of the thin film layer 305 can substantially conform to the shape of the recessed surfaces 234 of the imprinting layer 213. Movement of the stamper 201 into the thin film layer 305 may stop when the recessed surfaces 234 of the stamper 201 contact the thin film layer 305, due to additional resistance. This additional resistance is due to the sudden increase in contact area when the entire imprinting surface of the stamper 201 is in contact with the thin film 305. Because the compressive pressure is distributed over the entire contact area, the compressive pressure over the depressed regions 311 can decrease when the compressive force is constant. The thin film 305 can reflow until it conforms to the shape or surface contour of the data features 232 and the timing track features 230 of the stamper 201. The thin film layer 305 can be cured with the entire imprinting surface of the master template 201 in full contact with the thin film layer 305.

The method used to cure the thin film 305 depends upon the type of thin film material being used. The thin film can commonly be cured through heat or light exposure as ultra violet (UV) light. If the thin film is cured with heat, the stamper 201, substrate 301 and thin film 305 may be heated to the cure temperature of the thin film 305. Alternatively, if UV light is used, the stamper 201 can be made of a UV transparent material such as glass or quartz which can be transmitted through the stamper 201 to the thin film 305. After the thin film is cured, the stamper 201 may be removed from the thin film 305.

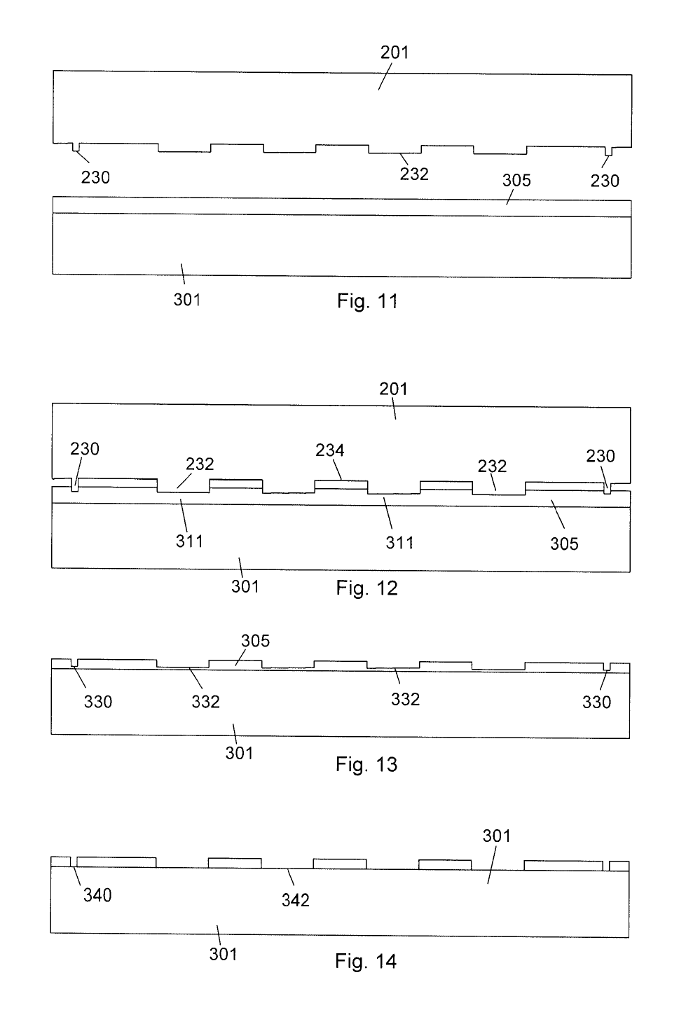

With reference to FIG. 13, the cross-sectional surface contour of the thin film layer 305 is illustrated. The imprinted thin film layer 305 includes a plurality of recesses formed at compressed regions 315 in the data area and recesses 311 formed in the timing track area. With reference to FIG. 14, the surface-imprinted thin film 305 is subjected to etch processing to remove the residual material at the bottom of the compressed portions 330, 332 to selectively expose portions of the underlying substrate 301 in the imprinting layer pattern which includes the data area surfaces 342 and the timing trace surfaces 340. Selective removal of the compressed portions 330, 332 may be accomplished by any appropriate process, such as reactive ion etching (RIE) or wet chemical etching.

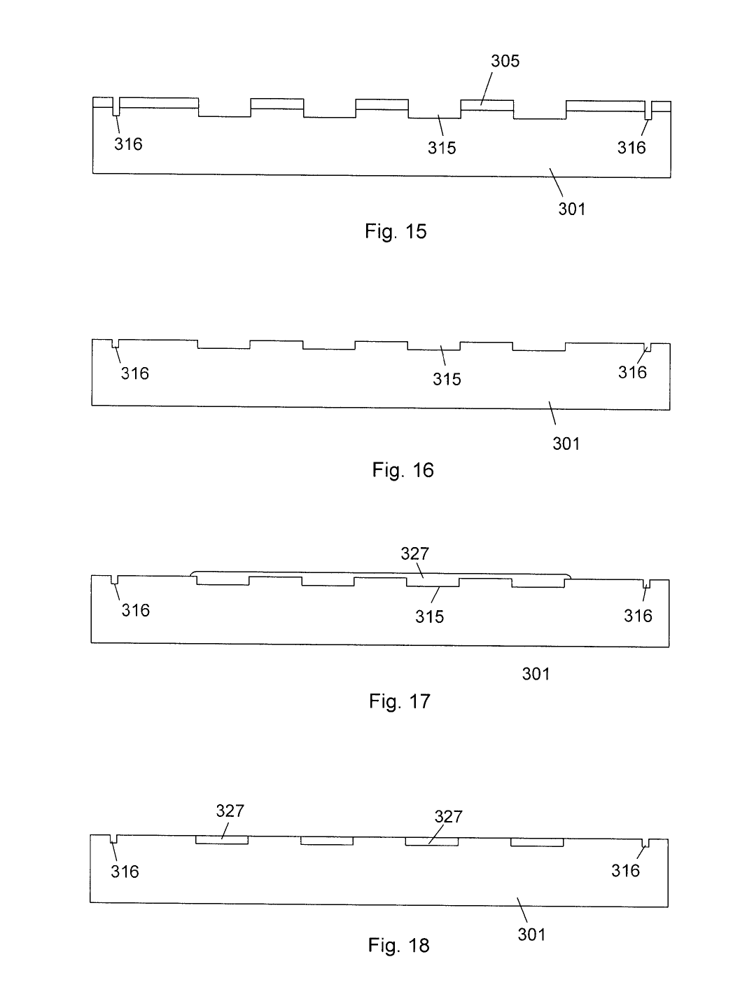

With reference to FIG. 15, etching of the patterned magnetic media disk substrate is performed on the exposed areas of the substrate 301 that are not covered by the resist 305. The etching creates the final timing track 316 and the recessed data area patterns 315. With reference to FIG. 16, after the master template 301 is etched, the resist material 305 is removed. With reference to FIG. 17, a hard magnetic material 327 is deposited into the recesses in the data pattern area 315 but not the final timing track 316. Excess hard magnetic material 327 can overfill the recesses 325. With reference to FIG. 18, the excess hard magnetic material 327 is planarized so the tops of the hard magnetic elements 329 are flush with the top edge of the recesses 325. The planarization process can be performed through chemical-mechanical polishing (CMP) or other planarization process. Each of the plurality of elements forms a single magnetic domain of a bit patterned medium. Additional processing can be performed to complete the BPM such as applying a protective layer over the top of the substrate of filling the areas between the hard magnetic elements 327 with other materials.

Although the timing track has been described as being located adjacent to an outer diameter of the master template, in other embodiments, the timing track can be located on other areas of the master template. With reference to FIG. 19, the timing track area 196 can be close to the center of the master template 194 and the final timing track 198 can be adjacent to an inner diameter of a data storage area 153. Since the center portion of the disk media can be placed on a spindle, most of the timing area 196 can be removed from the disk media.

After a patterned magnetic media disk having a final timing track is formed, it is installed in a disk drive. FIG. 20 is an isometric view of a disc drive 900 which includes a housing with a base 902 and a top cover (not shown). Disc drive 900 further includes a disc pack 906, which is mounted on a spindle motor (not shown) by a disc clamp 908. Disc pack 906 includes a plurality of individual discs, which are mounted for co-rotation about central axis 909. Each disc surface has an associated disc head slider 910 which is mounted to disc drive 900 for communication with the disc surface. In the example shown in FIG. 19, sliders 910 are supported by suspensions 912 which are in turn attached to track accessing arms 914 of an actuator 916. The actuator 916 can be a rotary moving coil actuator and includes a voice coil motor (VCM), shown generally at 918. Voice coil motor 918 rotates actuator 916 with its attached heads 910 about a pivot shaft 920 to position heads 910 over a desired data track along an arcuate path 922 between a disc inner diameter 924 and a disc outer diameter 926. Voice coil motor 918 is driven by servo electronics 930 based on signals generated by heads 910 and a host computer (not shown).

In an embodiment, one side of one of the multiple individual discs includes the final timing track 916. Because the disks on the disc pack 926 are rigidly coupled together, the timing data from one of the disks may be used for the disks. In this illustration, the top surface of the top BPM disk includes the final timing track 316. In other embodiments, the final timing track can be close to the inner diameter 924 of the top disk, the bottom surface of the bottom disk or on any other surface of the other disks of the disk drive 900 that can be detected with an MR sensor or an optical sensor.

The final timing track 316 is etched in the disk media substrate and read by the timing track sensor 978. In an embodiment, the timing track sensor 978 is a magneto-resistive (MR) sensor or an optical sensor that is used to read the final timing track and not the magnetic data recorded onto the disks. The final timing track data is read by the disk drive to determine the angular position of the disks. In an embodiment, the timing track data is processed by the disk drive and used to write the permanent servo information on the BPM disks using the write heads 910. The servo information is then used by the disk drive to help determine the angular position of the disks and record data to the disks and read data from the disks. In other embodiments, the disk drive can record data to the disks and read data from the disks without the servo data written to the disk media.

During normal operation of the disk drive 900, data is written to and read from the individual discs by disc head slider 916, wherein each individual disc would be accompanied by an individual disc head 910 and an individual timing track sensor 922. The disc head 910 is positioned over individual tracks of each disc by actuator 918 and voice coil motor 920. In this way, as spindle 909 rotates the discs, voice coil motor 920 and actuator 918 position the disc head 910 over a desired track, such that data can be written to or read from the disc 906.

The present disclosure, in various embodiments, includes components, methods, processes, systems and/or apparatus substantially as depicted and described herein, including various embodiments, subcombinations, and subsets thereof.

What is claimed is:

1. An apparatus comprising:
a substrate;
a data storage area on the substrate;
a timing track area on the substrate, the timing track area adjacent to the data storage area; and
a timing track etched into the timing track area, the timing track having rotational timing data.

2. The apparatus of claim 1 wherein the timing track area is adjacent to an outer diameter of the apparatus.

3. The apparatus of claim 1 wherein the timing track area is adjacent to an inner diameter of the data storage area.

4. The apparatus of claim 1 wherein the timing track area is less than 5 mm wide.

5. The apparatus of claim 1 wherein the timing track is annular and includes grating features that extend across a width of the timing track.

6. The apparatus of claim 1 wherein timing errors in the timing track are less than 2 nanoseconds.

7. A method comprising:
etching a timing track in a timing track area of a substrate;
determining whether there are errors in the timing track and a magnitude of the errors;
calculating estimated corrections to the timing track based upon the determining;
etching an additional timing track in the timing track area based on the estimated corrections; and
repeating the determining, the calculating and the etching steps, until the magnitude of the errors in the timing track is below a predetermined error level.

8. The method of claim 7 further comprising:
removing the timing tracks from the timing track area other than the timing track that was etched last.

9. The method of claim 7 wherein the determining includes reading timing data from the timing track with an optical sensor.

10. The method of claim 7 wherein the determining includes identifying repeatable timing errors.

11. The method of claim 10 wherein the determining includes applying a phase lock loop inverse error transfer function to the repeatable timing errors.

12. The method of claim 7 wherein the predetermined error level is 2 nanoseconds.

13. A method comprising:
creating a master template that includes a data area and a timing track area having a timing track;
forming a stamper from the master template that includes a stamper data area and a stamper timing track area having a stamper timing track;
forming a pattern in a resist layer on a substrate using the stamper;
etching the substrate to form a media data area and a media timing track area having a media timing track; and
depositing a hard magnetic material in the media data area of the substrate and not on the media timing track.

14. The method of claim 13 further comprising:
determining whether there are errors in the timing track on the master template and a magnitude of the errors;
calculating estimated corrections to the timing track based upon the determining;
etching an additional timing track in the timing track area of the master template based on the estimated corrections; and
repeating the determining, the calculating and the etching steps, until the errors in the magnitude of the errors in the timing track is below a predetermined error level.

15. The method of claim 14 further comprising:
removing all of the timing tracks from the timing track area on the master template other than the timing track that was etched last.

16. The method of claim 14 wherein the determining includes reading timing data from the timing track on the master template with an optical sensor.

17. The method of claim 14 wherein the determining includes identifying repeatable timing errors.

18. The method of claim 14 wherein the determining includes applying a phase lock loop inverse error transfer function to the repeatable timing errors.

19. The method of claim 14 wherein the etching includes etching grating features in the timing tracks that extend across widths of the timing tracks.

20. The method of claim 14 wherein the predetermined error level is 2 nanoseconds.
